(19) United States
(12) Patent Application Publication
(10) Pub. No.: US 2026/0052080 A1
(43) Pub. Date: Feb. 19, 2026

(54) TECHNOLOGIES FOR LAYER 2 AUTOMATIC REPEAT REQUEST IN A WIRELESS NETWORK

(71) Applicant: Apple Inc., Cupertino, CA (US)

(72) Inventors: Fangli Xu, Beijing (CN); Haijing Hu, Los Gatos, CA (US); Naveen Kumar R. Palle Venkata, San Diego, CA (US); Peng Cheng, Beijing (CN); Ping-Heng Kuo, London (GB); Ralf Rossbach, Munich (DE); Yuqin Chen, Beijing (CN)

(73) Assignee: Apple Inc., Cupertino, CA (US)

(21) Appl. No.: 19/274,457

(22) Filed: Jul. 18, 2025

Related U.S. Application Data
(60) Provisional application No. 63/684,781, filed on Aug. 19, 2024.

(51) Int. Cl. H04L 41/50; H04L 1/00; H04L 1/1867

(52) U.S. Cl. CPC H04L 41/5032; H04L 1/0003; H04L 1/1896

(57) ABSTRACT

The present application relates to devices and components including apparatus, systems, and methods for layer 2 (L2) automatic repeat request (ARQ) operation.

### CROSS-REFERENCE TO RELATED APPLICATION

This application claims the benefit of U.S. Provisional Ser. No. 63/684,781, filed on Aug. 19, 2024, which is herein incorporated by reference in its entirety for all purposes.

### TECHNICAL FIELD

This application relates generally to communication networks and, in particular, to technologies for layer 2 automatic repeat request in a wireless network.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates example aspects of a user equipment, a distributed unit, and a centralized unit, in accordance with some embodiments.

FIG. 3 illustrates an example procedure for layer 2 (L2) automatic repeat request (ARQ) in accordance with some embodiments.

FIG. 4 illustrates another example procedure for L2 ARQ in accordance with some embodiments.

FIG. 5 illustrates another example procedure for L2 ARQ in accordance with some embodiments.

FIG. 6 illustrates examples of a transmission window and a reception window, in accordance with some embodiments.

FIG. 7 illustrates another example procedure for L2 ARQ in accordance with some embodiments.

FIG. 8 illustrates another example procedure for L2 ARQ in accordance with some embodiments.

FIG. 9 illustrates an operational flow/algorithmic structure in accordance with some embodiments.

FIG. 10 illustrates another operational flow/algorithmic structure in accordance with some embodiments.

FIG. 11 illustrates a user equipment in accordance with some embodiments.

FIG. 12 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

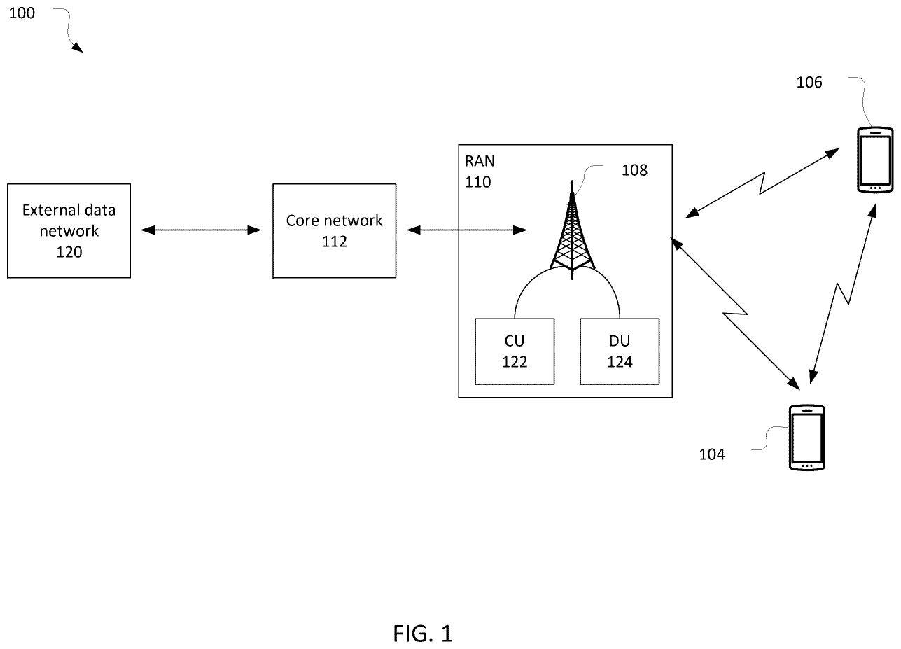

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system (e.g., Sixth Generation (6G) system). The base station 108 may provide user plane and control plane protocol terminations toward the UE 104.

The network environment 100 may further include a core network (CN) 112. For example, the CN 112 may comprise a 5^{th} Generation Core network (5GC), a 6th Generation Core network (6GC), or later generation core network. The CN 112 may be coupled to the base station 108 via a fiber optic or wireless backhaul. The CN 112 may provide functions for the UE 104 via the base station 108. These functions may include managing subscriber profile information, subscriber location, authentication of services, or switching functions for voice and data sessions.

The network environment 100 may further include an external data network 120, which may be accessed by the UE 104 via the RAN 110.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

In various embodiments, the base station 108 may include a split architecture that includes a centralized unit (CU) 122 and a distributed unit (DU) 124. In some embodiments, a plurality of DUs, including DU 124 may be coupled to the same CU 122. In general, the CU 122 may handle higher-layer protocols, for example, radio resource control (RRC), packet data convergence (PDCP), and service data adaptation protocol (SDAP) layer protocols, while the DU 124 handles lower-layer protocols, for example, radio link control (RLC), media access control (MAC), and physical (PHY) layer protocols.

The PHY layer may correspond to a layer 1 (L1) and may be responsible for establishing and maintaining a physical link between the UE 104 and the RAN 110 via an air interface. The MAC layer, RLC layer, PDCP layer, and SDAP layer may be sublayers of a layer 2 (L2). L2 may be responsible for managing the connectivity of the UE 104 and movement between cells and networks, among other functions.

The CU 122 may provide control-plane (CP) functionality by, for example, a CU-CP component, and user-plane (UP) functionality by, for example, a CU-UP component. In some embodiments, the DU 124 may additionally provide CP functionality by, for example, a DU-control (C) component, and UP functionality by, for example, a DU-user (U) component.

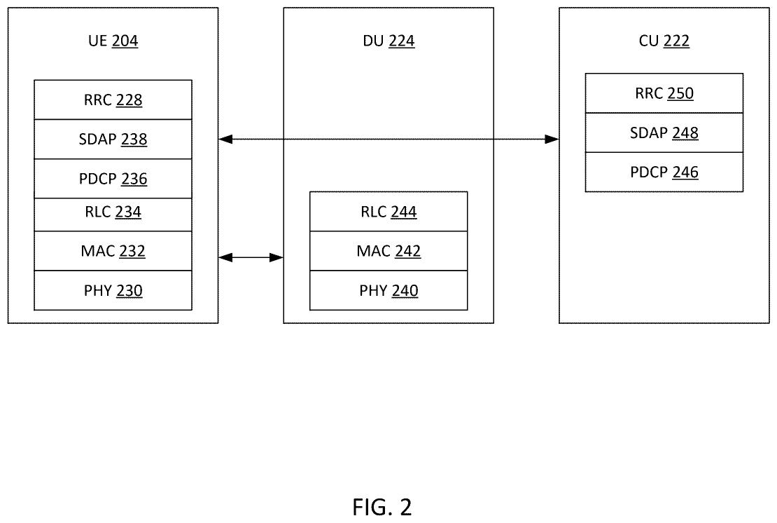

FIG. 2 illustrates example protocol stacks of a UE 204, a CU 222 and a DU 224 in accordance with some embodiments. The UE 204, CU 222, and DU 224 may correspond to the UE 104, CU 122, and DU 124, respectively, of FIG. 1. As shown, the UE 204 may include a PHY layer 230, a MAC layer 232, an RLC layer 234, a PDCP layer 236, a SDAP layer 238, and/or an RRC layer 228. The DU 224 may include a PHY layer 240, a MAC layer 242, and/or an RLC layer 244. The CU 222 may include a PDCP layer 246, a SDAP layer 248, and/or an RRC layer 250. The protocol stack of a respective device may be implemented by circuitry (e.g., processor circuitry), which may include different circuitries, overlapping circuitries, or the same circuitry to implement different layers of the protocol stack.

At the transmit side, a packet may be passed down to lower layers for transmission via the PHY layer (e.g., PHY layer 230 for an uplink transmission and PHY layer 240 for a downlink transmission). The lower layers may segment data from higher layers and add sequence numbers (SNs) and headers. At the receive side, the packet may be passed from the respective PHY layer (e.g., PHY layer 240 for the uplink transmission and PHY layer 230 for the downlink transmission) to higher layers. Packets may be reassembled back into the original data, e.g., using the SNs and/or header information to arrange the data in the correct order and detect any missing packets. In embodiments, an automatic repeat request (ARQ) procedure may be used to request re-transmission of a packet that was not successfully received by the receive side, as discussed further herein.

In some instances, a packet received by a layer from a higher layer is called the service data unit (SDU) of that layer. The packet transmitted by the layer to lower layers is called the protocol data unit (PDU) of that layer. For example, packets received by an RLC layer from a PDCP layer are called RLC SDUs, and packets sent by an RLC layer to a MAC layer are called RLC PDUs.

In embodiments, the PDCP layer (e.g., PDCP layer 236 and/or PDCP layer 246) may perform functions including: transfer of data (e.g., user plane or control plane); maintenance of PDCP SNs; header compression and decompression (e.g., using robust header compressing (ROHC) protocol and/or Ethernet header compression (EHC) protocol); uplink data compression and decompression; ciphering and deciphering; integrity protection and integrity verification; timer-based SDU discard; and/or functions for split bearers and/or DAPS bearer (e.g., routing, duplication, reordering for in-order delivery, out-of-order delivery, and/or duplicate discarding).

The RLC layer (e.g., RLC layer 234 and/or RLC layer 244) may perform functions including: error correction (e.g., via ARQ); segmentation and reassembly of RLC SDUs; re-segmentation of RLC SDU segments; duplicate detection; RLS SDU discard; RLC re-establishment; and/or protocol error detection.

In embodiments, different transmission modes may be supported by respective protocol layers of the UE 204 and/or the RAN (e.g., DU 224 and/or CU 222). For example, the transmission mode may be a transparent mode (TM), an unacknowledged mode (UM), or an acknowledged mode (AM). In 5G, the PDCP layer supports UM and AM modes, while the RLC layer supports TM, UM, and AM modes.

In TM mode, the transmit entity of the RLC layer does not segment the RLC SDUs, and does not include any RLC headers in the TM data (TMD) PDUs. Accordingly, the RLC SDUs are passed through as TMD PDUs. The receive entity of the RLC layer may deliver the TMD PDUs to the upper layer (e.g., PDCP).

In UM mode, the transmit entity of the RLC layer segments the RLC SDUs and includes RLC headers in the UM data (UMD) PDUs. The receive entity of the corresponding RLC layer detects the loss of RLC SDU segments at lower layers. The receive entity reassembles the RLC SDUs from the received UMD PDUs and delivers the RLC SDUs to the upper layer. The receive entity further discards received UMD PDUs that cannot be reassembled into an RLC SDU (e.g., due to loss of an UMD PDU which belonged to the RLC SDU).

In AM mode, the transmit entity of the RLC layer segments the RLC SDUs and includes RLC headers in the AM data (AMD) PDUs. The transmit entity can further retransmit a RLC SDU based on a RLC status report, and implements a polling scheme to request the RLC status report. The receive entity of the corresponding RLC layer detects loss of one or more AMD PDUs at the lower layers and requests retransmission by the peer entity. The receive entity reassembles RLC SDUs from the received AMD PDUs and delivers the RLS SDUs to the upper layer. The receive entity may further include duplication detection functionality to detect receipt of duplicate segments.

Accordingly, in RLC AM mode, no transmission data loss is allowed. Retransmission of a segment is based on the RLC status report, which may be triggered by a poll bit in a received AMD PDU from the transmit entity or a reception failure detection at the receive side. Additionally, RLC AM mode supports segment-based retransmission. The transmit entity of the RLC layer may include a transmission buffer and a retransmission buffer to store data waiting for acknowledgement (ACK) from the corresponding receive entity.

The PDCP layer in 5G also supports ARQ mechanisms. However, PDCP ARQ mechanisms may allow data loss after a waiting for the packet for the duration of a wait timer. Additionally, retransmission may be based on a PDCP status report, which may be triggered by a RRC procedure. Furthermore, PDCP ARQ mechanisms only support PDU level retransmission (not segment-level retransmission).

Various embodiments herein provide mechanisms to enhance PDCP ARQ to provide reliable data transmission in L2. In some embodiments, the ARQ functionality in the RLC layer may be simplified or omitted, e.g., to avoid redundancy. The techniques described herein may provide additional benefits in a split CU-DU architecture, e.g., in which the RLC layer is implemented in the DU and the PDCP layer is implemented in the CU. For example, having ARQ control in the DU increases complexity of the DU. Additionally, the DU may be required to have a RLC transmission buffer and/or retransmission buffer, which increases the memory requirement of the DU. Furthermore, future networks (e.g., 6G networks) may have more reliable transport at the MAC and/or PHY layers (e.g., via techniques such as distributed multiple input, multiple output (MIMO), hybrid ARQ (HARQ), etc.). Accordingly, there may be less benefit to having ARQ functionality in the RLC layer, and the L2 ARQ functionality may be provided by the PDCP layer without significant degradation in performance.

Various models for L2 ARQ are provided herein. In a first ARQ model, the L2 ARQ may be performed entirely in the PDCP layer and not the RLC layer. In a second ARQ model, the PDCP layer may perform PDU-level ARQ, and the RLC layer may perform segmentation and reassembly without ARQ. In a third ARQ model, the PDCP layer may perform PDU-level ARQ and the RLC layer may perform segment-level ARQ.

Various embodiments herein further provide techniques to support transmission modes with different quality-of-service (QoS) levels in the PDCP layer. For example, the PDCP layer may support a first transmission mode that is lossless (e.g., packets that begin transition will not lose data). The PDCP layer may further support and a second transmission mode that is less strict but is still reliable. For example, the second transmission mode may provide lossless transmission within a validity period of data packets. The transmission mode used may depend, for example, on the needs of the associated service.

Additionally, some embodiments herein provide techniques to support cross-path ARQ retransmission in PDCP. The cross-path retransmission may improve the robustness of the ARQ performance.

As discussed above, in a first ARQ model in accordance with embodiments herein, L2 ARQ may be performed entirely in the PDCP layer (e.g., PDCP layer 236 and/or PDCP layer 246) and not in the RLC layer. The PDCP layer may support ARQ on a PDCP SDU basis and/or on a segment basis (e.g., if segmentation is supported in L2). The PDCP layer may perform the SDU segmentation and reassembly function. The RLC layer may be skipped in the ARQ procedure and/or assumed to be configured as UM mode or TM mode.

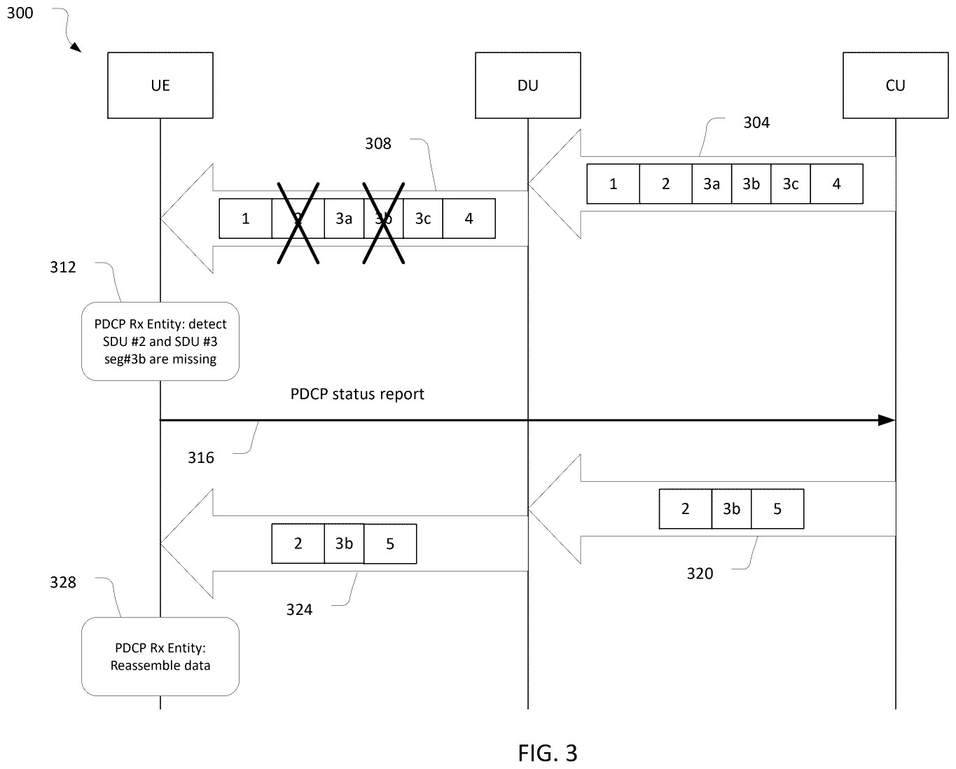

FIG. 3 illustrates an example ARQ procedure 300 in accordance with various embodiments. Aspects of the procedure 300 may be performed by the PDCP layer of the CU (e.g., PDCP layer 246 of CU 222) and/or the PDCP layer of the UE (e.g., PDCP layer 236 of UE 204). The procedure 300 is described with reference to a downlink transmission from the CU to the UE. However, a similar procedure may be performed for an uplink transmission from the UE to the CU and/or for a sidelink transmission from a UE to another UE.

At 304, the PDCP layer of the CU may transmit data to a UE via a DU. The data may include SDUs #s 1, 2, 3, and 4, with SDU #3 including segments 3a, 3b, and 3c. The SDUs may be associated with respective SNs. The PDCP layer of the CU may support segmentation of SDUs, e.g., to generate segments 3a, 3b, and 3c from SDU #3. The PDCP layer may determine to segment a SDU and/or the size of the segments based on one or more factors, such as a predicted uplink grant and/or configuration information. A PDCP PDU that includes a segment may further include segment information in a header of the PDCP PDU. The segment information may indicate a location of the segment in the corresponding PDCP SDU (e.g., a segment offset (SO) start and/or a SO end).

At 308 of the procedure 300, the PDCP layer of the UE may successfully receive a subset of the data transmitted by the CU. For example, the PDCP layer of the UE may receive SDU #1, segment #3a, segment #3c, and SDU #4, while SDU #2 and segment #3b may be missing (not successfully received).

At 312 of the procedure 300, the PDCP layer of the UE may detect that some of the data is missing. For example, the UE may detect the missing SDU based on the SNs of the received SDUs (e.g., there is a gap in the SNs of the received SDUs). The UE may detect the missing segment based on segment information in the header of a PDCP PDU (e.g., indicating that the PDU includes multiple segments) and/or in the received segments.

At 316 of the procedure 300, the PDCP layer of the UE may transmit a PDCP status report to the PDCP layer of the CU. The PDCP status report may include an indication of the missing SDU (e.g., the associated SN and/or a count value) and the missing segment (e.g., a SO start and a SO end of the missing segment). In embodiments, the PDCP status report may include ACK information (indicating data that was successfully received, e.g., based on SN information, count value information, and/or SO information) and/or negative acknowledgement (NACK) information (indicating data that was not successfully received).

In some embodiments, the PDCP status report may be triggered by the PDCP receive entity (e.g., triggered based on detection of the missing data at 312 of the procedure 300). In other embodiments, the PDCP status report may be requested by the PDCP transmit entity (e.g., CU in this example). For example, a PDCP status report request (also referred to as a polling request) may be included in a PDCP data PDU header and/or a PDCP control PDU header transmitted by the CU to the UE.

In some embodiments, the CU may request periodical PDCP status reports. For example, the UE may start a timer based on transmission of a first PDCP status report. Upon expiration of the timer, the UE may transmit a second PDCP status report (e.g., if the UE has feedback to report for one or more packets). In some embodiments, the first PDCP status report that is the basis for the subsequent periodic second PDCP status report may be event triggered.

In other embodiments, the CU may request a PDCP status report from the UE based on one or more triggering events. The one or more triggering events may include, for example: there is new data to send but the transmission window has stalled; the amount of transmitted data exceeds a threshold; the number of transmitted PDUs exceeds a threshold; all PDCP SDUs in the transmission buffer have been transmitted; the retransmission number for a packet (and/or averaged across multiple packets) exceeds a threshold; and/or a trigger received from an upper layer (e.g., RRC).

In some embodiments, the receive entity (e.g., UE in this example) may maintain a polling prohibit timer. The UE may start the polling prohibit timer based on transmission of a first PDCP status report and may be prohibited from transmitting another PDCP status report before expiration of the polling prohibit timer. This may reduce the frequency of PDCP status report transmission. In some embodiments, a PDCP status report may still be triggered by the upper layer (e.g., RRC) while the polling prohibit timer is running.

The receive entity (e.g., UE in this example) may additionally or alternatively trigger transmission of a PDCP status report based on one or more events, such as: polling information carried in the received PDCP PDU; detection of a SN gap in the PDCP reception window; detection of a missing segment of a PDCP packet; identification that one or more missing packets have become unnecessary (e.g., the associated validity time has expired as discussed further below); detection of reception failure for a number of consecutive PDCP PDUs that is greater than a threshold; a PDCP PDU decompression and/or deciphering failure; receipt of a PDCP PDU with a PDCP SN outside of the reception window; and/or a radio quality (e.g., if a radio quality is less than a threshold and there is missing data).

In some embodiments, the PDCP status report may include a field that indicates the event that triggered the PDCP status report (or indicates that the PDCP status report is a periodic report).

At 320 of the procedure 300, the PDCP layer of the CU may retransmit the missing data (e.g., SDU #2 and segment #3b of SDU #3). The retransmitted PDCP SDU may have a same SN as the initial transmission. In some embodiments, the retransmitted segment may have a same location in the respective PDCP SDU as in the initial transmission. In some instances, the PDCP layer may also include new data (e.g., SDU #5).

In some embodiments, the PDCP layer of the CU may receive ACK/NACK feedback from a lower layer of the CU (e.g., via the HARQ procedure). The PDCP layer of the CU may determine the missing data based on the ACK/NACK feedback and the PDCP status report.

In some embodiments, the missing data may include data in the transmission buffer (e.g., that is included in the current transmission window) for which the CU did not receive an ACK (e.g., in the PDCP status report and/or in the ACK/NACK feedback from lower layers). The CU may remove the PDCP SDUs from the transmission buffer for which an ACK was received, and trigger retransmission of the PDCP SDUs and/or segments for which an ACK was not received. Additionally, the CU may update the transmission window and/or trigger a request for a PDCP status report (polling information) if the respective conditions are met.

In some embodiments, the PDCP layer at the transmit side (e.g., the CU in this example) may support resegmentation for the retransmission of a missing segment. For example, the PDCP transmit entity may generate a segment for transmission that includes the missing segment of the prior transmission and new data. The retransmission may include segment information (e.g., SO start and SO end) for the generated segment.

At 324 of the procedure 300, the PDCP layer of the UE may receive the missing data. At 328 of the procedure 300, the PDCP layer may reassemble the data (e.g., reassemble PDCP SDU #3 with segments 3a, 3b, and 3c).

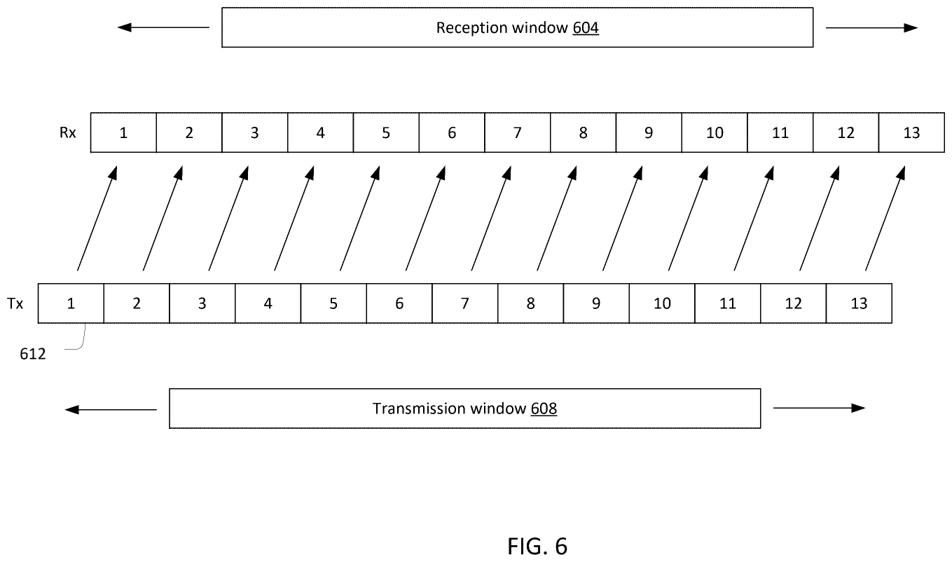

The PDCP transmit entity (e.g., in the CU in the example of FIG. 3) may maintain a transmission window (e.g., transmission window 608 of FIG. 6, discussed further below), e.g., to ensure that packets are successfully transmitted to the receive side. For example, the PDCP transmit entity may move the transmission window based on an indication that all data of a transmitted packet was received by the peer entity (e.g., an ACK was received for all data of the transmitted packet). The transmitted packet may be kept in a transmission buffer until all data of the packet is transmitted successfully.

In some embodiments, the PDCP transmit entity may inform an upper layer (e.g., RRC layer) of a failure if one or more conditions occur, such as when a number of retransmissions per packet exceeds a threshold.

The PDCP receive entity (e.g., in the UE in the example of FIG. 3) may maintain a reception window (e.g., the reception window 604 of FIG. 6). The PDCP receive entity may only process received packets that are in the reception window. The PDCP receive entity may move the reception window (e.g., to process a successive packet) based on consecutive successfully received PDCP SDU information (e.g., indicating that the PDCP receive entity has successfully received the earliest data in the current reception window). The PDCP receive entity may further include a reordering buffer for duplication detection and/or reordering. The reordering buffer may store received data (e.g., SDUs and/or segments) and reorder the received data to be in consecutive SNs and/or segments without duplicates.

As discussed above, a second ARQ model may be used, in accordance with some embodiments, in which the PDCP layer performs PDU-level ARQ and the RLC layer performs segmentation and reassembly without ARQ. For example, the RLC layer at the transmit side may segment PDCP SDUs that are provided from the PDCP layer for transmission. The RLC layer at the receive side may perform reassembly of the received segments. The RLC layer at the receive side may detect a reassembly failure if all the segments for a PDCP SDU have not been successfully received (e.g., within the duration of a reassmelby timer) and inform the PDCP layer of the reassembly failure. The PDCP layer may include the corresponding PDCP SDU in the PDCP status report to request retransmission.

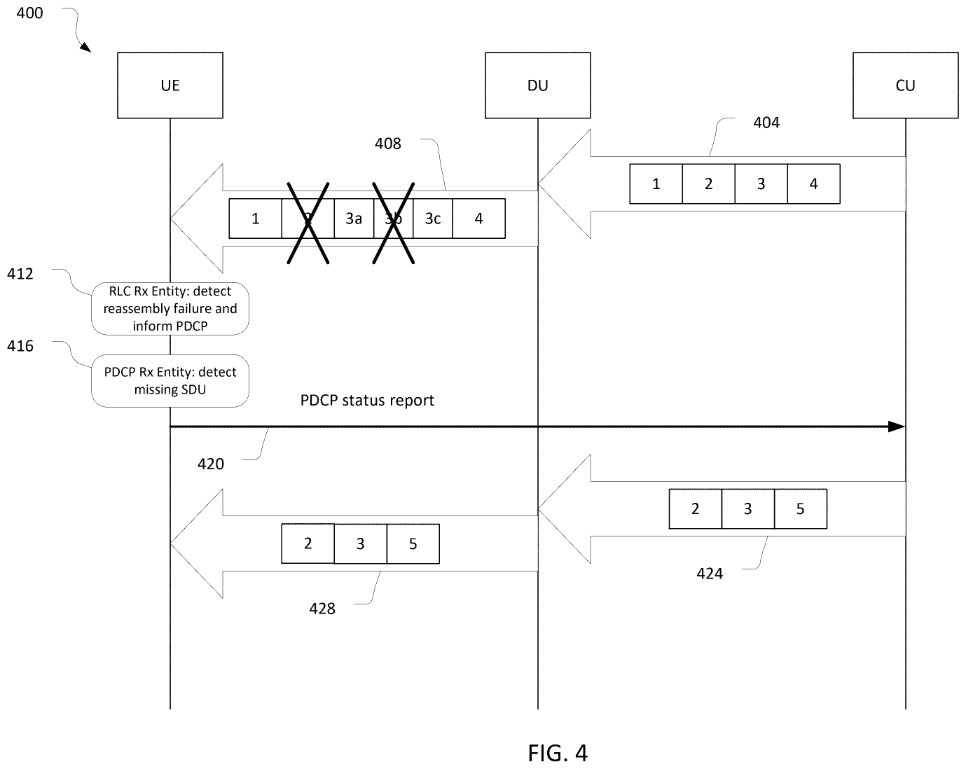

FIG. 4 illustrates an example procedure 400 in accordance with various embodiments. Aspects of the procedure 400 may be performed by the PDCP layer of the CU (e.g., PDCP layer 246 of CU 222), the RLC layer of the DU (e.g., RLC layer 244 of DU 224), the PDCP layer of the UE (e.g., PDCP layer 236 of UE 204), and/or the RLC layer of the UE (e.g., RLC layer 234 of UE 204). The procedure 400 is described with reference to a downlink transmission from the CU to the UE (e.g., with the CU as transmit entity and the UE as receive entity). However, a similar procedure may be performed for an uplink transmission from the UE to the CU and/or for a sidelink transmission from a UE to another UE.

At 404, the PDCP layer of the CU may generate data for transmission to the UE and send the data to the RLC layer of the DU. The data may include SDUs #1, 2, 3, and 4. In the procedure 400, the PDCP layer may send the SDUs to the DU without segmentation.

The RLC layer of the DU may receive the data from the PDCP layer and may segment one or more of the SDUs. In some embodiments, the determination of whether or not to segment a SDU and/or the segment size may be based on information from another layer, e.g., from the MAC layer.

At 408 of the procedure 400, the DU may transmit the segmented data to the UE. The segmented data may include SDUs #1, 2, and 4, and segments 3a, 3b, and 3c corresponding to SDU #3. A RLC PDU that includes a segment may further include segment information in a header of the RLC PDU. The segment information may indicate a location of the segment in the corresponding RLC SDU (e.g., a SO start and/or a SO end).

As shown in FIG. 4, the UE may successfully receive a subset of the data from the DU. For example, the UE may receive SDU #1, segment #3a, segment #3c, and SDU #4, while SDU #2 and segment #3b may be missing (not successfully received).

The RLC layer of the UE may perform reassembly of received segments to generate the corresponding SDU. In some embodiments, the RLC layer of the UE may maintain a reception window (e.g., a pull window) for duplication detection and/or reassembly of received segments. At 412 of the procedure 400, the RLC may detect a reassembly failure based on a missing segment (e.g., a reassembly failure for SDU #3 based on missing segment 3b). In some embodiments, the reassembly failure may be detected based on expiration of a reassembly timer (e.g., started based on receipt of a first segment of the corresponding SDU). The length of the reassembly timer may be configured by the network. The RLC layer may inform the PDCP layer of the reassembly failure. In some embodiments, the RLC layer may discard the received segments based on the detected reassembly failure, e.g., since the PDCP layer may request retransmission of the entire SDU.

At 416 of the procedure 400, the PDCP layer of the UE may detect a missing SDU, e.g., SDU #2. Accordingly, the PDCP layer may detect when an entire SDU has not been received (e.g., an unsegmented SDU and/or a segmented SDU for which no segments have been received).

At 420 of the procedure 400, the PDCP layer may generate a PDCP status report for transmission to the CU. The PDCP status report may identify one or more PDCP SDUs that were not successfully received by the UE, e.g., SDUs #2 and 3.

At 424 of the procedure 400, the PDCP layer of the CU may retransmit the PDCU SDUs that were indicated as missing, e.g., SDUs #2 and 3. The CU may also include new data in the transmission, e.g., SDU #5.

At 428 of the procedure 400, the UE may receive the retransmission of the missing SDUs.

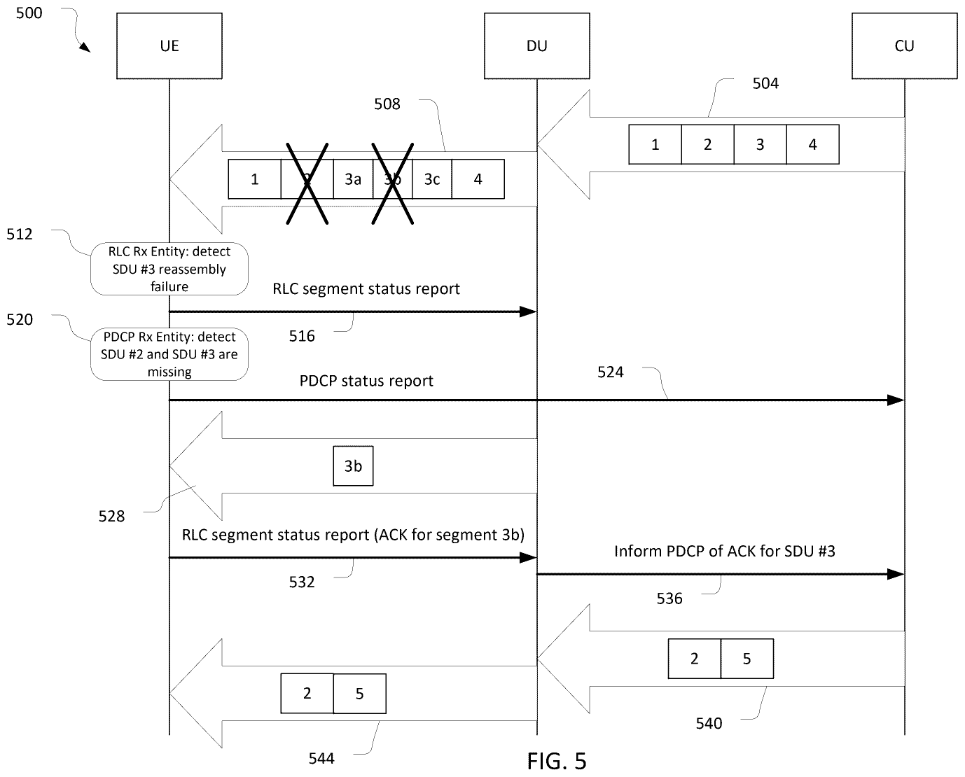

In a third ARQ model, the PDCP layer may perform PDU-level ARQ and the RLC layer may perform segment-level ARQ. FIG. 5 illustrates an example procedure 500 in accordance with various embodiments. Aspects of the procedure 500 may be performed by the PDCP layer of the CU (e.g., PDCP layer 246 of CU 222), the RLC layer of the DU (e.g., RLC layer 244 of DU 224), the PDCP layer of the UE (e.g., PDCP layer 236 of UE 204), and/or the RLC layer of the UE (e.g., RLC layer 234 of UE 204). The procedure 500 is described with reference to a downlink transmission from the CU to the UE (e.g., with the CU as transmit entity and the UE as receive entity). However, a similar procedure may be performed for an uplink transmission from the UE to the CU and/or for a sidelink transmission from a UE to another UE.

At 504, the PDCP layer of the CU may generate data for transmission to the UE and send the data to the RLC layer of the DU. The data may include SDUs #1, 2, 3, and 4. In the procedure 500, the PDCP layer may send the SDUs to the DU without segmentation.

The RLC layer of the DU may receive the data from the PDCP layer and may segment one or more of the SDUs. In some embodiments, the determination of whether or not to segment a SDU and/or the segment size may be based on information from another layer, e.g., from the MAC layer.

At 508 of the procedure 500, the DU may transmit the segmented data to the UE. The segmented data may include SDUs #1, 2, and 4, and segments 3a, 3b, and 3c corresponding to SDU #3. A RLC PDU that includes a segment may further include segment information in a header of the RLC PDU. The segment information may indicate a location of the segment in the corresponding RLC SDU (e.g., a SO start and/or a SO end).

As shown in FIG. 5, the UE may successfully receive a subset of the data from the DU. For example, the UE may receive SDU #1, segment #3a, segment #3c, and SDU #4, while SDU #2 and segment #3b may be missing (not successfully received).

The RLC layer of the UE may perform reassembly of received segments to generate the corresponding SDU. In some embodiments, the RLC layer of the UE may maintain a reception window (e.g., a pull window) for duplication detection and/or reassembly of received segments. At 512 of the procedure 500, the RLC layer may detect a reassembly failure based on a missing segment (e.g., a reassembly failure for SDU #3 based on missing segment 3b). As discussed above with respect to operation 412 of procedure 400, the reassembly failure may be detected based on expiration of a reassembly timer (e.g., started based on receipt of a first segment of the corresponding SDU).

At 516 of the procedure 500, the RLC layer of the UE may generate a RLC segment status report for transmission to the DU. The RLC segment status report may indicate that segment 3b of SDU #3 was not successfully received. The receive entity of the RLC layer may initiate a RLC segment status report based on, for example, detection of a missing segment, a SDU reassembly failure within a time period (e.g., the duration of a reassembly timer), and/or periodically (e.g., based on a periodical timer). In some embodiments, a prohibit timer may be used to limit the frequency of RLC segment status report transmission.

The RLC layer of the UE may pass the received SDUs (e.g., SDUs #1 and 4) to the PDCP layer of the UE. In some embodiments, the RLC layer may indicate that a reassembly failure occurred for SDU #3. At 520, the PDCP layer may detect that SDUs #2 and 3 are missing. At 524, the PDCP layer may generate a PDCP status report for transmission to the CU. The PDCP status report may indicate that SDUs #2 and 3 are missing (e.g., may include a NACK for the SNs associated with SDUs #2 and 3). Accordingly, the PDCP status report may include SDU-level feedback information, while the RLC segment status report may include segment-level feedback information.

At 528 of the procedure 500, the DU may retransmit the missing segment indicated by the RLC segment status report (e.g., segment 3b). The RLC layer may receive the segment 3b and reassemble SDU #3 using the segment 3b and previously received segments 3a and 3c (which may be stored in a receive buffer maintained by the RLC layer). In some embodiments, the RLC layer may inform a higher layer (e.g., PDCP layer and/or RRC layer) of an error if one or more conditions are met, such as if the number of retransmissions for the same RLC segment exceeds a threshold. Based on the error indication, the RRC layer may trigger a link recovery procedure and/or the PDCP layer may trigger retransmission of the PDCP SDU via another link (e.g., as discussed further herein).

At 532 of the procedure 500, the RLC layer of the UE may generate a RLC segment status report that includes an ACK for segment 3b and/or SDU #3. At 536, the RLC layer of the DU may inform the PDCP layer of the CU that an ACK has been received for all segments of SDU #3. Accordingly, the PDCP layer of the CU may identify that the UE has successfully received SDU #3 and may determine not to retransmit SDU #3. At 540, the PDCP layer of the CU may retransmit SDU #2. In some cases, the PDCP layer may also include new data, e.g., SDU #5. At 544, the PDCP layer of the UE may receive the retransmitted SDU #2 (and the new data, if applicable).

Accordingly, the procedure 500 may provide segmentation and reassembly, including segment-based ARQ, at the RLC layer, while SDU-based ARQ is provided at the PDCP layer.

In some embodiments, the PDCP ARQ mechanism (e.g., in accordance with procedure 300, 400, and/or 500) may support one or more QoS requirements. For example, PDCP ARQ may use a first transmission mode that is lossless (e.g., packets that begin transition will not lose data) and/or a second transmission mode that provides lossless transmission subject to a validity period of data packets. The transmission mode used may depend, for example, on the needs of the associated service. For example, the first transmission mode may be used for services that require high reliability with high latency. The second transmission mode may be used for services that require high reliability with low latency.

The PDCP transmit entity and PDCP receive entity may maintain a respective transmission window and reception window. The transmission window and reception window may correspond to a set of data packets (e.g., based on respective SNs and/or count values). For example, FIG. 6 illustrates a reception window 604 and a transmit window 608 associated with a set of SDUs and/or PDUs 612. The SDUs and/or PDUs 612 may be associated with respective SNs and/or count values. The PCP transmit entity and PDCP receive entity may move the respective transmission window 608 or reception window 604 based on one or more conditions. In some embodiments, the conditions may be different for the first transmission mode and the second transmission mode.

In the first transmission mode (lossless ARQ), the transmit entity may not allow transmission of data that is outside of the current transmission window (e.g., transmission window 608). For example, new data that is received by the PDCP layer for transmission may not be transmitted if the transmission window is stalled. The PDCP transmit entity may move the transmit window based on ACK feedback from the peer entity (e.g., the PDCP status report from the PDCP layer of the receive side) and/or from a lower layer (e.g., HARQ ACK feedback and/or RLC segment-based ACK feedback). For example, the PDCP transmit entity may move the transmit window if an ACK is received for one or more earliest SDUs of the current transmit window.

If the transmission window stalls (e.g., does not move for a period of time and/or moves too slowly), the PDCP transmit entity may request a PDCP status report from the peer entity. The PDCP layer may determine a PDCP transmission failure based on one or more conditions, such as if a number of retransmissions for a same packet reaches a maximum number (which may be configured by the network in some embodiments). The PDCP layer may notify a higher layer, such as the RRC layer, of the determined PDCP transmission failure.

At the receive side, the PDCP receive entity may process data that is within the reception window (e.g., reception window 604). The PDCP receive entity may not process any data that is received that is outside the current reception window. The PDCP receive entity may move the reception window based on successfully receiving one or more of the earliest SDUs in the reception window (e.g., receiving the data in sequence from the lower layer, such as the RLC layer).

For the second transmission mode, the transmission window and/or reception window may be updated based on the respective conditions discussed above with respect to the first transmission mode and/or one or more other conditions. For example, the PDCP receive entity may update the reception window based on expiration of a reordering timer. In some embodiments, the reordering timer may be started based on detection of a gap in the received PDUs (e.g., a SN gap). The PDCP receive entity may move (e.g., push) the reception window based on expiration of the reordering timer. For example, the PDCP reception window may move the lower edge of the reception window to the next packet that has not been received (e.g., the next gap). In some embodiments, the length of the reordering window may be configured by the network. Additionally, or alternatively, the length of the reordering window may be based on a type of PDU (e.g., a priority level of the PDU).

In some embodiments, the PDCP receive entity may additionally or alternatively move the reception window based on receiving a packet that has a high priority level (e.g., a threshold importance or greater) and is outside the current reception window. For example, the upper edge or lower edge of the reception window may be moved to include the high priority packet.

In some embodiments, the PDCP receive entity may trigger transmission of a PDCP status report based on movement of the reception window and/or the associated condition.

The PDCP transmit entity may move the transmission window based on receiving ACK feedback in a PDCP status report and/or via a lower layer, as discussed above with respect to the first transmission mode. Additionally, in some embodiments, one or more PDCP SDUs may have an associated validity time. The PDCP transmit entity may discard a PDCP SDU from the transmission window upon expiration of the validity time (e.g., based on a discard timer associated with one or more SDUs stored in the transmission window). The PDCP transmit entity may update the transmission window based on the discarded PDCP SDU.

In some embodiments, the PDCP SDU may additionally or alternatively move the transmission window if an important packet (e.g., with a high priority level) is ready for transmission but outside the current transmission window (e.g., the transmission window is stalling). For example, the PDCP transmit entity may discard one or more of the earliest PDCP SDUs in the transmission window that are awaiting an ACK and update the transmission window accordingly (e.g., to encompass the important packet). In some embodiments, the PDCP transmit entity may assume that the discarded PDCP SDUs were successfully received by the peer entity.

In some embodiments, the PDCP transmit entity may inform the peer entity of movement of the transmission window, e.g., under certain circumstances. The PDCP receive entity may update the reception window based on the movement of the transmission window.

Various embodiments herein further provide mechanisms for cross-path ARQ transmission. There may be multiple paths between the UE and the network. For example, the UE may be connected to a base station (e.g., a CU of a base station) via: multiple transmission-reception points (TRPs) and/or radio units (RUs); via multiple DUs; via a terrestrial network (TN) and a non-terrestrial network (NTN); and/or via a sidelink interface and a Uu interface. In some embodiments, the retransmission of a data packet use a different path than the initial transmission. For example, the initial transmission may be on a first path and the retransmission may be on a second path. In some embodiments, the change in data path may be based on a radio quality (e.g., one or more signal quality measurements, such as a reference signal received power (RSRP)) associated with the first path and/or second path. In some embodiments, the retransmission may be performed on multiple paths (e.g., the first and second paths or the second path and a third path). A new path may be additionally or alternatively selected for transmission of a new PDCP SDU.

In some embodiments, the retransmission may be performed on a same path as the initial transmission, but with a higher (more robust) modulation and coding scheme (MCS). In some instances, a higher MCS on the same path may be used if another path is unavailable (or another path with better radio quality is not available).

Various techniques may be used to select the path selected for a PDCP SDU transmission (e.g., retransmission or initial transmission). In some embodiments, the receive device may indicate a path to use. For example, the receive device may indicate the path explicitly in a PDCP status report and/or dedicated signaling (e.g., L1 and/or L2 signaling). Alternatively, the receive device may indicate the path implicitly, e.g., by transmitting the PDCP status report on the preferred path. In other embodiments, the receive device may indicate measurement results for the current path and/or preferred path to the transmit device. For example, the measurement results may be included in a PDCP status report.

In some embodiments, the new path may be selected at the transmit side. For example, the transmit device may select the path based on quality information associated with the candidate paths, e.g., via radio quality measurements, ACK/NACK feedback, and/or an artificial intelligence (AI)/machine learning (ML) prediction. Additionally, or alternatively, the transmit device may select the path based on a number of retransmissions that have been performed for a PDCP SDU (e.g., if the number is greater than a threshold, then a different path is selected). In some embodiments, the path may be selected based on a priority level of the packet and/or a remaining delay budget of the PDCP SDU. For example, different paths may be associated with different QoS requirements. In some embodiments, the path may be selected based on the number of PDCP SDUs that are awaiting retransmission (e.g., in the transmission buffer).

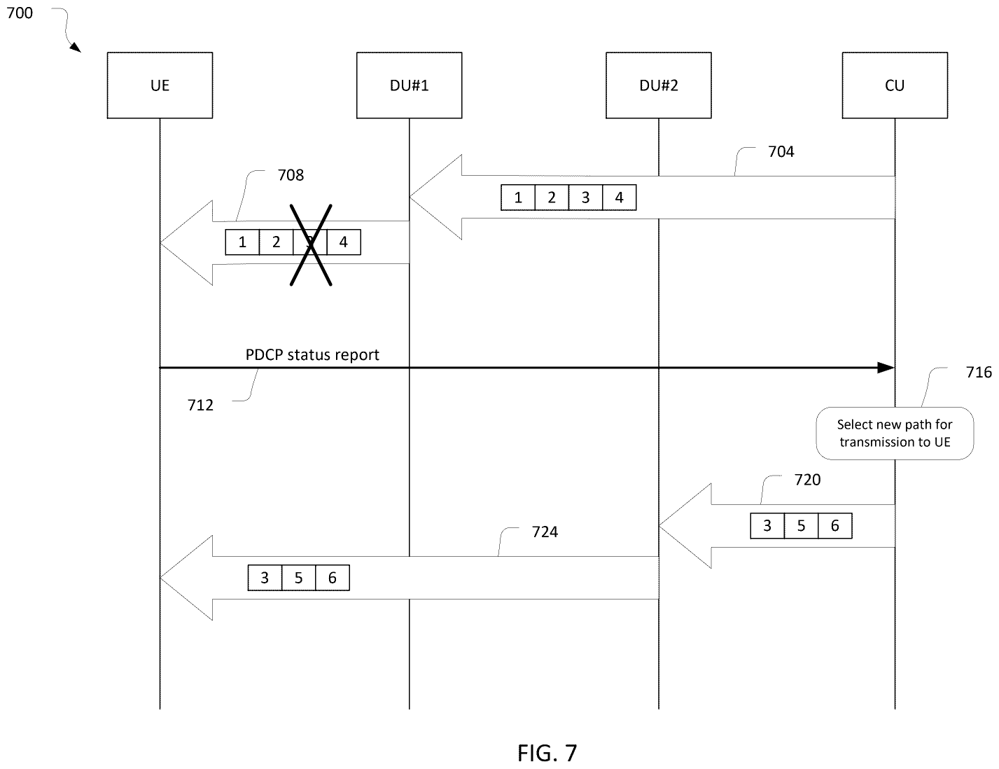

FIG. 7 illustrates an example procedure 700 in accordance with some embodiments. In this scenario, the UE may have a RRC connection with two DUs, DU #1 and DU #2, that are associated with the same CU.

At 704, the CU may transmit data to the UE, via DU #1, that includes multiple SDUs (e.g., SDUs #1, 2, 3, and 4). At 708, the UE may successfully receive SDUs #1, 2, and 4, but not SDU #3.

At 712, the UE may transmit a PDCP status report to the CU. The PDCP status report may indicate that SDU #3 was not successfully received (e.g., may include a NACK for SDU #3). In some embodiments, the PDCP status report may further include an indication of a preferred path and/or measurement results associated with a current path and/or the preferred path. The preferred path may be, for example, via DU #2.

At 716, the CU may select a new path for retransmission of the missing SDU (e.g., SDU #3). For example, the new path may be via DU #2. At 720, the CU may transmit data to the UE, via DU #2, that includes the missing SDU (SDU #3). The transmission may further include new data (e.g., SDUs #5 and 6). At 724, the UE may successfully receive the data, including SDU #3.

In some embodiments, the PDCP status report at 712 may indicate a last received SDU instead of or in addition to indicating a gap in the received SDUs. In this case, the PDCP status report may indicate that SDU #2 is the last received SDU. The CU may then retransmit both SDU #3 and SDU #4.

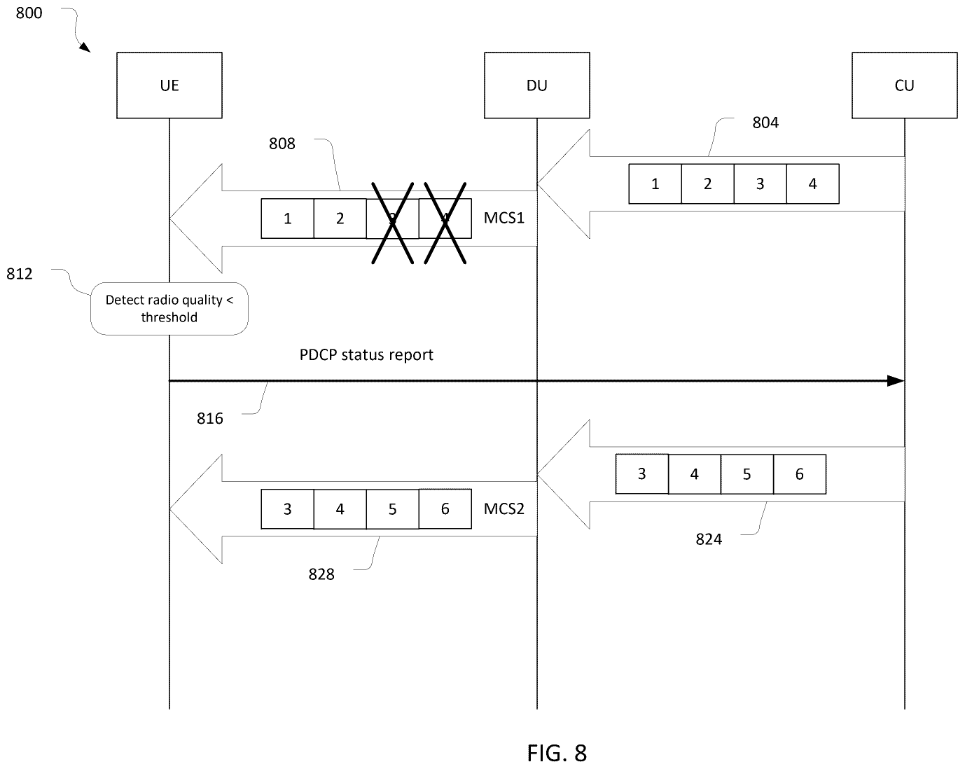

FIG. 8 illustrates another example procedure 800 in accordance with various embodiments. In the procedure 800, the retransmission may be performed on a same path but with a higher (more robust) MCS.

At 804 of the procedure 800, the CU may transmit data to the UE, via the DU, that includes multiple SDUs (e.g., SDUs #1, 2, 3, and 4). At 808, the DU may apply a first MCS (MCS1) for transmission of the data to the UE. The UE may successfully receive SDUs #1 and 2, but not SDUs #3 and 4.

At 812, the UE may detect that the radio quality on the path between the UE and the DU is below a threshold. The UE may trigger a PDCP status report based on the detection. The UE may not know that it missed any SDUs since it did not receive an SDU with a later SN. Accordingly, the PDCP status report triggered by the low radio quality may alert the CU that the UE has not received all the transmitted SDUs.

At 816, the UE may transmit a PDCP status report to the CU. In some embodiments, the PDCP status report may indicate a last SDU that was successfully received (e.g., SDU #2 in this case).

In some embodiments, the PDCP status report may include an indication that the radio quality of the path is poor. For example, the PDCP status report may include an indication that the PDCP status report was triggered by the radio quality being below the threshold. Additionally, or alternatively, the PDCP status report may include one or more measurement results associated with the path.

At 820 of the procedure 800, the CU may retransmit the missing SDUs (e.g., SDUs #3 and 4). At 820, the DU may apply a second MCS (e.g., MCS2) that is more robust (e.g., includes additional transmission layers and/or a more robust modulation scheme) than the first MCS that was used for the transmission at 804. The DU may receive instructions to increase the MCS from the CU via higher layers. In some instances, the transmission at 816 may further include new data. At 820, the UE may successfully receive SDUs #3 and 4.

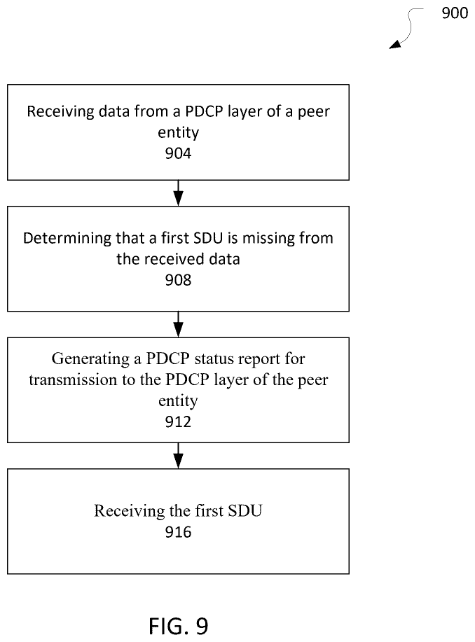

FIG. 9 is an operational flow/algorithmic structure 900 that for L2 ARQ in accordance with some embodiments. The operational flow/algorithmic structure 900 may be implemented by a UE such as, for example, UE 104, UE 204, UE 1100, or components thereof; for example, a baseband processor 1104A. Alternatively, the operational flow/algorithmic structure 900 may be implemented by a network device, such as base station 108, CU 122, DU 124, CU 222, DU 224, network device 1200, or components thereof, for example, processors 1204A.

The operational flow/algorithmic structure 900 may include, at 904, receiving data from a PDCP layer of a transmit entity. In embodiments in which the operational flow/algorithmic structure 900 is implemented by a UE, the transmit entity may be, for example, a base station (e.g., a CU and/or DU of a base station) or another UE. In embodiments in which the operational flow/algorithmic structure 900 is implemented by a base station (e.g., a CU of a base station), the transmit entity may be a UE.

The operational flow/algorithmic structure 900 may further include, at 908, determining that a first SDU is missing from the received data. In some embodiments, the determination may be based on, for example, a gap in the SNs and/or count values of the received data. Additionally, or alternatively, the determination may be based on a notification from a lower layer (e.g., RLC layer), such as a notification of a reassembly failure for the first SDU.

The operational flow/algorithmic structure 900 may further include, at 912, generating a PDCP status report for transmission to the PDCP layer of the transmit entity. The PDCP status report may include, for example, an identifier of the first SDU, such as a SN or a count value of the first SDU.

The operational flow/algorithmic structure 900 may further include, at 916, receiving the first SDU. For example, the first SDU may be retransmitted from the PDCP layer of the transmit entity.

In some embodiments, the PDCP status report may further indicate that a first segment of a second SDU was missing from the received data. The operational flow/algorithmic structure may further include receiving the first segment and reassembling the second SDU based on the first segment.

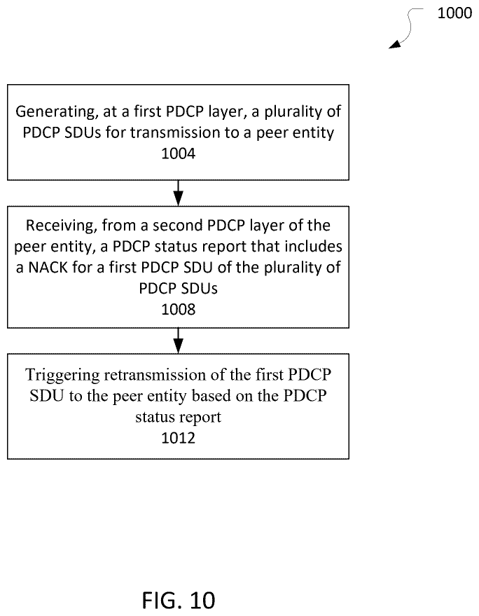

FIG. 10 is an operational flow/algorithmic structure 1000 that for L2 ARQ in accordance with some embodiments. The operational flow/algorithmic structure 1000 may be implemented by a UE such as, for example, UE 104, UE 204, UE 1100, or components thereof; for example, a baseband processor 1104A. Alternatively, the operational flow/algorithmic structure 1000 may be implemented by a network device, such as base station 108, CU 122, DU 124, CU 222, DU 224, network device 1200, or components thereof, for example, processors 1204A.

The operational flow/algorithmic structure 1000 may include, at 1004, generating, at a first PDCP layer, a plurality of PDCP SDUs for transmission to a receive entity. In embodiments in which the operational flow/algorithmic structure 1000 is implemented by a UE, the receive entity may be, for example, a base station (e.g., a CU and/or DU of a base station) or another UE. In embodiments in which the operational flow/algorithmic structure 1000 is implemented by a base station (e.g., a CU of a base station), the receive entity may be a UE.

The operational flow/algorithmic structure 1000 may further include, at 1008, receiving, from a second PDCP layer of the receive entity, a PDCP status report that includes a NACK for a first PDCP SDU of the plurality of PDCP SDUs.

The operational flow/algorithmic structure 1000 may further include, at 1012, triggering retransmission of the first PDCP SDU to the receive entity based on the PDCP status report.

In some embodiments, the PDCP status report may further include a NACK for a first segment of a second SDU. Alternatively, a RLC segment status report may be received that indicates the NACK for the first segment of the second SDU. The operational flow/algorithmic structure may further include triggering retransmission of the first segment of the second SDU.

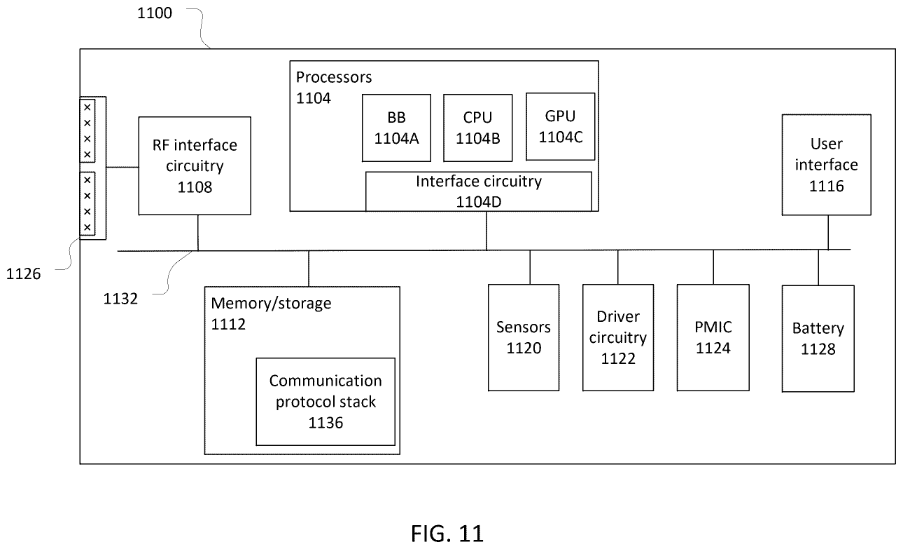

FIG. 11 illustrates a UE 1100 in accordance with some embodiments. The UE 1100 may be similar to and substantially interchangeable with UE 104, UE 106, and/or UE 204.

The UE 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1100 may include processors 1104, RF interface circuitry 1108, memory/storage 1112, user interface 1116, sensors 1120, driver circuitry 1122, power management integrated circuit (PMIC) 1124, antenna 1126, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1132, which may represent any type of interface, input/output, bus (local, system, or expansion), transmission line, trace, or optical connection that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform operations as described herein (e.g., operations associated with L2 ARQ). The processors 1104 may also include interface circuitry 1104D to communicatively couple the processor circuitry with one or more other components of the UE 1100.

In some embodiments, the baseband processor 1104A may access a communication protocol stack 1136 in the memory/storage 1112 to communicate over a 3GPP compatible network. In general, the baseband processor 1104A may access the communication protocol stack 1136 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1108.

The baseband processor 1104A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1112 may include one or more non-transitory, computer-readable media that includes instructions (for example, communication protocol stack 1136) that may be executed by one or more of the processors 1104 to cause the UE 1100 to perform operations as described herein (e.g., operations associated with L2 ARQ).

The memory/storage 1112 includes any type of volatile or non-volatile memory that may be distributed throughout the UE 1100. In some embodiments, some of the memory/storage 1112 may be located on the processors 1104 themselves (for example, memory/storage 1112 may be part of a chipset that corresponds to the baseband processor 1104A), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1108 may include transceiver circuitry and a radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1126 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1126.

In various embodiments, the RF interface circuitry 1108 may be configured to transmit/receive signals in a manner compatible with NR access technologies.

The antenna 1126 may include antenna elements to convert electrical signals into radio waves to travel through the air and to convert received radio waves into electrical signals. The antenna elements may be arranged into one or more antenna panels. The antenna 1126 may have antenna panels that are omnidirectional, directional, or a combination thereof to enable beamforming and multiple input, multiple output communications. The antenna 1126 may include microstrip antennas, printed antennas fabricated on the surface of one or more printed circuit boards, patch antennas, or phased array antennas. The antenna 1126 may have one or more panels designed for specific frequency bands including bands in FR1 or FR2.

The user interface 1116 includes various input/output (I/O) devices designed to enable user interaction with the UE 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1100.

The sensors 1120 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of sensors 1120 and control and allow access to sensors 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

A battery 1128 may power the UE 1100, although in some examples the UE 1100 may be mounted deployed in a fixed location and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

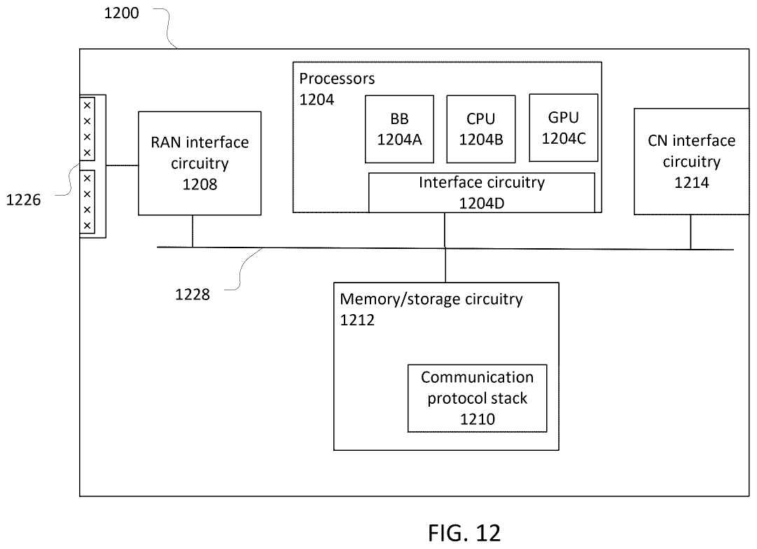

FIG. 12 illustrates a network device 1200 in accordance with some embodiments. The network device 1200 may be similar to, and substantially interchangeable with, the base station 108, the CU 122, the DU 124, the CU 222, and/or the DU 224, and/or a component of the CN 112.

The network device 1200 may include processors 1204, RF interface circuitry 1208 (if implemented as a base station), core network (CN) interface circuitry 1214, memory/storage circuitry 1212, and antenna structure 1226.

The components of the network device 1200 may be coupled with various other components over one or more interconnects 1228.

The processors 1204, RF interface circuitry 1208, memory/storage circuitry 1212 (including communication protocol stack 1210), antenna structure 1226, and interconnects 1228 may be similar to like-named elements shown and described with respect to FIG. 11.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage circuitry 1212 to cause the network device 1200 to perform operations as described herein (e.g., operations associated with L2 ARQ). The processors 1204 may also include interface circuitry 1204D to communicatively couple the processor circuitry with one or more other components of the network device 1200.

The CN interface circuitry 1214 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1200 via a fiber optic or wireless backhaul. The CN interface circuitry 1214 may include one or more dedicated processors or FPGAs to communicate using one or more of the aforementioned protocols. In some implementations, the CN interface circuitry 1214 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

Example 1 may include a method comprising: receiving data from a packet data convergence protocol (PDCP) layer of a transmit entity; determining that a first service data unit (SDU) is missing from the data; generating a PDCP status report for transmission to the PDCP layer of the transmit entity, wherein the PDCP status report includes an identifier of the first SDU; and receiving the first SDU based on the PDCP status report.

Example 2 may include the method of example 1 or some other example herein, wherein the received data includes one or more segments of a second SDU, and wherein the method further comprises: detecting an SDU reassembly error for the second SDU based on a missing segment, wherein the generated PDCP status report includes, based on the detection, an indication of the missing segment; receiving the missing segment based on the PDCP status report; and reassembling the second SDU based on the missing segment and the one or more segments in the data.

Example 3 may include the method of example 2 or some other example herein, wherein the indication of the missing segment includes a segment offset (SO) start value and a SO end value.

Example 4 may include the method of example 1 or some other example herein, further comprising: receiving, from a radio link control (RLC) layer, an indication of a reassembly error for a second SDU, wherein the generated PDCP status report further includes, based on the indication, an identifier of the second SDU; and receiving the second SDU based on the PDCP status report.

Example 5 may include the method of example 1 or some other example herein, further comprising: detecting, at a first radio link control (RLC) layer, an SDU reassembly error for a second SDU based on a missing segment; generating a RLC segment status report for transmission to a second RLC layer of the transmit entity based on the detected SDU reassembly error; receiving, from the second RLC layer of the transmit entity, the missing segment; reassembling the second SDU based on the missing segment; and passing the reassembled second SDU to a higher layer.

Example 6 may include the method of example 5 or some other example herein, wherein the RLC segment status report is a first RLC segment status report, and wherein the method further comprises generating a second RLC segment status report for transmission to the second RLC layer, wherein the second RLC segment status report includes an acknowledgement of the receipt of the missing segment.

Example 7 may include the method of example 1 or some other example herein, further comprising maintaining a receiving window that corresponds to a set of packets, wherein received packets that are within the receiving window are processed and received packets that are outside the receiving window are discarded, and wherein the maintaining the receiving window includes updating the receiving window based on successful receipt of an earliest packet of the set of packets.

Example 8 may include the method of example 1 or some other example herein, further comprising maintaining a receiving window that corresponds to a set of packets, wherein the maintaining the receiving window includes updating the receiving window based on any one of: successful receipt of an earliest packet of the set of packets; expiration of a reordering timer that is started based on detection of a sequence number gap; or receiving a packet that is outside the receiving window and has a priority level of a threshold level or greater.

Example 9 may include the method of example 1 or some other example herein, wherein the PDCP status report includes an indication that a radio quality of a path on which the data was received is below a threshold.

Example 10 may include the method of example 9 or some other example herein, wherein the path is a first path and wherein the first SDU is received via a second path that is different from the first path.

Example 11 may include the method of example 9 or some other example herein, wherein the data is received with a first modulation and coding scheme (MCS) and the first SDU is received with a second MCS that is more robust than the first MCS.

Example 12 may include the method of example 1 or some other example herein, wherein the transmit entity is a base station, a centralized unit (CU), a distributed unit (DU), or a user equipment (UE).

Example 13 may include a method comprising: generating, at a first packet data convergence protocol (PDCP) layer, a plurality of PDCP service data units (SDUs) for transmission to a receive entity; receiving, from a second PDCP layer of the receive entity, a PDCP status report that includes a negative acknowledgment (NACK) for a first PDCP SDU of the plurality of PDCP SDUs; and triggering retransmission of the first PDCP SDU to the receive entity based on the PDCP status report.

Example 14 may include the method of example 13 or some other example herein, wherein the PDCP status report further includes a NACK for a first segment of a second SDU of the plurality of SDUs, and wherein the method further comprises triggering retransmission of the first segment of the second SDU based on the PDCP status report.

Example 15 may include the method of example 14 or some other example herein, wherein the PDCP status report includes a segment offset (SO) start value and a SO end value of the first segment.

Example 16 may include the method of example 13 or some other example herein, further comprising: receiving, at a first radio link control (RLC) layer, a RLC segment status report from a second RLC layer of the receive entity, wherein the RLC segment status report includes a NACK for a first segment of a second PDCP SDU of the plurality of PDCP SDUs, and wherein the method further comprises triggering retransmission of the first segment of the second PDCP SDU.

Example 17 may include the method of example 13 or some other example herein, wherein the PDCP status report further includes a NACK for a second PDCP SDU of the plurality of PDCP SDUs, and wherein the method further comprises: receiving, from a radio link control (RLC) layer, an indication that all segments of the second PDCP SDU have been acknowledged by the receive entity; and discarding the second PDCP SDU from a retransmission buffer based on the indication from the RLC layer.

Example 18 may include the method of example 13 or some other example herein, further comprising maintaining a transmission window that corresponds to a set of packets that are permitted to be transmitted or retransmitted, and wherein the maintaining the transmission window includes updating the transmission window based on receipt of an acknowledgment (ACK) for an earliest packet of the set of packets.

Example 19 may include the method of example 13 or some other example herein, further comprising maintaining a transmission window that corresponds to a set of packets, wherein the maintaining the transmission window includes updating the transmission window based on any one of: receipt of an acknowledgment (ACK) for an earliest packet of the set of packets; expiration of a validity time associated with one or more packets of the set of packets; or a new packet with a priority level of a threshold level or higher is ready for transmission and outside of the transmission window.

Example 20 may include the method of example 13 or some other example herein, wherein the PDCP status report includes an indication that a radio quality of a path on which the plurality of PDCP SDUs were transmitted is below a threshold.

Example 21 may include the method of example 20 or some other example herein, wherein the first PDCP SDU is retransmitted via a different path based on the indication.

Example 22 may include the method of example 20 or some other example herein, wherein the plurality of PDCP SDUs are transmitted with a first modulation and coding scheme (MCS) and the first SDU is transmitted with a second MCS that is more robust than the first MCS based on the indication.

Example 23 may include the method of example 13 or some other example herein, wherein the receive entity is a user equipment (UE), a base station, a centralized unit (CU), or a distributed unit (DU).

Example 24 may include a baseband processor comprising: radio resource control (RRC) circuitry to establish RRC connections with a network via multiple paths; and packet data convergence protocol (PDCP) circuitry to: receive first data from a PDCP layer of the network via a first path; determine that a radio quality of the first path is below a threshold; generate, based on the determination a PDCP status report for transmission to the PDCP layer of the network; and receive, based on the PDCP status report, second data from the network via a second path.

Example 25 may include the baseband processor of example 24 or some other example herein, wherein the PDCP status report includes automatic repeat request (ARQ) feedback information for PDCP service data units (SDUs) of the first data.

Example 26 may include the baseband processor of example 25 or some other example herein, wherein the ARQ feedback information indicates that a first SDU was not successfully received, and wherein the first SDU is included in the received second data.

Example 27 may include the baseband processor of example 24 or some other example herein, wherein the PDCP status report indicates that the PDCP status report was triggered based on the radio quality of the first path being below the threshold.

Example 28 may include the baseband processor of example 24 or some other example herein, wherein the PDCP status report includes a first measurement result associated with the first path and a second measurement result associated with the second path.

Another example may include an apparatus comprising means to perform one or more elements of a method described in or related to any of examples 1-39, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-39, or any other method or process described herein.

Another example may include an apparatus comprising logic, modules, or circuitry to perform one or more elements of a method described in or related to any of examples 1-39, or any other method or process described herein.

Another example may include a method, technique, or process as described in or related to any of examples 1-39, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-39, or portions thereof.

Another example may include a signal as described in or related to any of examples 1-39, or portions or parts thereof.

Another example may include a datagram, information element, packet, frame, segment, PDU, or message as described in or related to any of examples 1-39, or portions or parts thereof, or otherwise described in the present disclosure.

Another example may include a signal encoded with data as described in or related to any of examples 1-39, or portions or parts thereof, or otherwise described in the present disclosure.

Another example may include a signal encoded with a datagram, IE, packet, frame, segment, PDU, or message as described in or related to any of examples 1-39, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-39, or portions thereof.

Another example may include a computer program comprising instructions, wherein execution of the program by a processing element is to cause the processing element to carry out the method, techniques, or process as described in or related to any of examples 1-39, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving data from a packet data convergence protocol (PDCP) layer of a transmit entity;
determining that a first service data unit (SDU) is missing from the data;
generating a PDCP status report for transmission to the PDCP layer of the transmit entity, wherein the PDCP status report includes an identifier of the first SDU; and
receiving the first SDU based on the PDCP status report.

2. The method of claim 1, wherein the received data includes one or more segments of a second SDU, and wherein the method further comprises:
detecting an SDU reassembly error for the second SDU based on a missing segment, wherein the generated PDCP status report includes, based on the detection, an indication of the missing segment;
receiving the missing segment based on the PDCP status report; and
reassembling the second SDU based on the missing segment and the one or more segments in the data.

3. The method of claim 2, wherein the indication of the missing segment includes a segment offset (SO) start value and an SO end value.

4. The method of claim 1, further comprising:
receiving, from a radio link control (RLC) layer, an indication of a reassembly error for a second SDU, wherein the PDCP status report further includes, based on the indication, an identifier of the second SDU; and
receiving the second SDU based on the PDCP status report.

5. The method of claim 1, further comprising:
detecting, at a first radio link control (RLC) layer, an SDU reassembly error for a second SDU based on a missing segment;
generating an RLC segment status report for transmission to a second RLC layer of the transmit entity based on the detected SDU reassembly error;
receiving, from the second RLC layer of the transmit entity, the missing segment;
reassembling the second SDU based on the missing segment; and
passing the reassembled second SDU to a higher layer.

6. The method of claim 5, wherein the RLC segment status report is a first RLC segment status report, and wherein the method further comprises generating a second RLC segment status report for transmission to the second RLC layer, wherein the second RLC segment status report includes an acknowledgement of receiving the missing segment.

7. The method of claim 1, further comprising maintaining a receiving window that corresponds to a set of packets, wherein the maintaining the receiving window includes updating the receiving window based on any one of:
successful receipt of an earliest packet of the set of packets;
expiration of a reordering timer that is started based on detection of a sequence number gap; or
receiving a packet that is outside the receiving window and has a priority level of a threshold level or greater.

8. The method of claim 1, wherein the PDCP status report includes an indication that a radio quality of a path on which the data was received is below a threshold.

9. The method of claim 8, wherein:
the path is a first path and wherein the first SDU is received via a second path that is different from the first path; or
the data is received with a first modulation and coding scheme (MCS) and the first SDU is received with a second MCS that is more robust than the first MCS.

10. A method comprising:
generating, at a first packet data convergence protocol (PDCP) layer, a plurality of PDCP service data units (SDUs) for transmission to a receive entity;
receiving, from a second PDCP layer of the receive entity, a PDCP status report that includes a negative acknowledgment (NACK) for a first PDCP SDU of the plurality of PDCP SDUs; and
triggering retransmission of the first PDCP SDU to the receive entity based on the PDCP status report.

11. The method of claim 10, wherein the NACK is a first NACK, wherein the PDCP status report further includes a second NACK for a first segment of a second SDU of the plurality of SDUs, and wherein the method further comprises triggering retransmission of the first segment of the second SDU based on the second NACK.

12. The method of claim 10, further comprising:
receiving, at a first radio link control (RLC) layer, a RLC segment status report from a second RLC layer of the receive entity, wherein the RLC segment status report includes a NACK for a first segment of a second PDCP SDU of the plurality of PDCP SDUs, and wherein the method further comprises triggering retransmission of the first segment of the second PDCP SDU.

13. The method of claim 10, wherein the NACK is a first NACK, wherein the PDCP status report further includes a second NACK for a second PDCP SDU of the plurality of PDCP SDUs, and wherein the method further comprises:
receiving, from a radio link control (RLC) layer, an indication that all segments of the second PDCP SDU have been acknowledged by the receive entity; and
discarding the second PDCP SDU from a retransmission buffer based on the indication from the RLC layer.

14. The method of claim 10, further comprising maintaining a transmission window that corresponds to a set of packets, wherein the maintaining the transmission window includes updating the transmission window based on any one of:
receipt of an acknowledgment (ACK) for an earliest packet of the set of packets;
expiration of a validity time associated with one or more packets of the set of packets; or
a new packet with a priority level of a threshold level or higher is ready for transmission and outside of the transmission window.

15. The method of claim 13, wherein the PDCP status report includes an indication that a radio quality of a path on which the plurality of PDCP SDUs were transmitted is below a threshold.

16. The method of claim 15, wherein:
the first PDCP SDU is retransmitted via a different path based on the indication; or
the plurality of PDCP SDUs are transmitted with a first modulation and coding scheme (MCS) and the first SDU is transmitted with a second MCS that is more robust than the first MCS based on the indication.

17. An apparatus comprising:
processor circuitry to implement a first packet data convergence protocol (PDCP) layer, the first PDCP layer to:
receive first data from a second PDCP layer of a network via a first path;
determine that a radio quality of the first path is below a threshold;
generate, based on the determination, a PDCP status report for transmission to the second PDCP layer of the network; and
receive, based on the PDCP status report, second data from the network via a second path; and
interface circuitry coupled to the processor circuitry to enable communication.

18. The apparatus of claim 17, wherein the PDCP status report includes automatic repeat request (ARQ) feedback information for PDCP service data units (SDUs) of the first data, wherein the ARQ feedback information indicates that a first SDU was not successfully received, and wherein the first SDU is included in the received second data.

19. The apparatus of claim 17, wherein the PDCP status report indicates that the PDCP status report was triggered based on the radio quality of the first path being below the threshold.

20. The apparatus of claim 17, wherein the PDCP status report includes a first measurement result associated with the first path and a second measurement result associated with the second path.
